(19) United States
(12) Patent Application Publication
(10) Pub. No.: US 2019/0056614 A1
(43) Pub. Date: Feb. 21, 2019

(54) COUNTER SUBSTRATE, LIQUID CRYSTAL DISPLAY PANEL AND METHOD FOR ELIMINATING BRIGHT SPOTS

(71) Applicants: BOE TECHNOLOGY GROUP CO., LTD., Beijing (CN); HEFEI XINSHENG OPTOELECTRONICS TECHNOLOGY CO., LTD., Hefei, Anhui (CN)

(72) Inventors: Yujuan ZHAN, Beijing (CN); Xuebing JIANG, Beijing (CN); Peng WU, Beijing (CN); Jilei GAO, Beijing (CN)

(21) Appl. No.: 15/764,303

(22) PCT Filed: Aug. 10, 2017
(86) PCT No.: PCT/CN2017/096790

§ 371 Date: Mar. 28, 2018

(30) Foreign Application Priority Data
Aug. 18, 2016 (CN) 201610688836.4

(51) Int. Cl. G02F 1/1339; G02F 1/1335; G02F 1/1368

(52) U.S. Cl. CPC G02F 1/13394; G02F 1/1368; G02F 1/133512

(57) ABSTRACT

The embodiments of the disclosure relate to the field of display technology and provide a counter substrate, a liquid crystal display panel and a method for eliminating bright spots, which can avoid bright spots caused by foreign bodies and reduce cost. The counter substrate includes a substrate, a black matrix and an orientation layer disposed on the substrate, and a wall. The black matrix at least includes a plurality of first light shielding strips. An orthographic projection of the wall on the substrate is covered by an orthographic projection of the plurality of first light shielding strips on the substrate. The wall extends along a first direction that intersects an orientation direction of the orientation layer.

### RELATED APPLICATIONS

The present application is the U.S. national phase entry of the international application PCT/CN2017/096790, with an international filing date of Aug. 10, 2017, which claims the benefit of Chinese Patent Application No. 201610688836.4, filed on Aug. 18, 2016, the entire disclosures of which are incorporated herein by reference.

### TECHNICAL FIELD

The present disclosure relates to the field of display technology, in particular to a counter substrate, a liquid crystal display panel and a method for eliminating bright spots.

### BACKGROUND

Liquid crystal displays (LCDs) have the advantages of low radiation, small size, and low energy consumption, and are widely used in electronic products such as a tablet computer, a television or a cell phone.

However, due to the long and complicated manufacturing process of a liquid crystal display panel, foreign bodies generated from inadequate cleaning or introduced in the manufacturing process often occur. With some foreign bodies float in the liquid crystal layer, when the liquid crystal display panel is lighted, if the foreign bodies are in the transparent area, bright spots will be seen. The presence of bright spots has a direct impact on the quality of the LCD panel.

### SUMMARY

The embodiments of the present disclosure provide a counter substrate, a liquid crystal display panel and a method for eliminating bright spots.

To this end, the embodiments of the present disclosure adopt the following technical solutions.

In a first aspect, the present disclosure provides a counter substrate. The counter substrate includes a substrate, a black matrix and an orientation layer disposed on the substrate, and a wall. The black matrix at least includes a plurality of first light shielding strips, and an orthographic projection of the wall on the substrate is covered by an orthographic projection of the plurality of first light shielding strips on the substrate. The wall extends along a first direction that intersects an orientation direction of the orientation layer.

Optionally, the first direction is perpendicular to the orientation direction of the orientation layer.

Optionally, a lateral width of the wall is smaller than a lateral width of the first light shielding strip.

Optionally, the black matrix includes a plurality of second light shielding strips extending along a second direction, the second direction is disposed to intersect with the first direction, and the wall is disposed between adjacent second light shielding strips.

Optionally, the wall has a tortuous shape.

Optionally, the black matrix further includes third light shielding strips. The third light shielding strips are disposed at the intersections of the first light shielding strips and the second light shielding strips. The orthographic projection of the wall on the substrate is covered by the orthographic projection of the first light shielding strip and the third light shielding strip on the substrate.

Further optionally, both ends of the wall along the first direction have protrusions extending opposite to the orientation direction.

Optionally, the number of the wall is multiple, and each wall corresponds to at least one sub-pixel.

Based on the above, optionally, the counter substrate further includes spacers. The material of the wall is the same as that of the spacers. The wall and the spacers are formed on the same layer.

In a second aspect, the present disclosure provides a liquid crystal display panel. The liquid crystal display panel includes the counter substrate described in the first aspect.

Optionally, the liquid crystal display panel includes thin film transistors (TFTs). The black matrix on the counter substrate includes third light shielding strips, and an orthographic projection of the third light shielding strips on the substrate of the counter substrate covers an orthographic projection of the thin film transistors on the substrate.

Optionally, the height of the walls is 0.1˜1 μm less than the thickness of the liquid crystal layer in the liquid crystal display panel.

In a third aspect, the present disclosure provides a method for eliminating bright spots in the liquid crystal display panel as described in the above embodiments. The method includes: determining whether bright spots move; and if bright spots move, lightening and aging the liquid crystal display panel until bright spots are blocked.

Optionally, the aging time is in the range of 0.5-3 h, and the aging temperature is in the range of 50-120° C.

### BRIEF DESCRIPTION OF THE DRAWINGS

In order to more clearly illustrate the technical solutions in embodiments of the disclosure or in the prior art, the appended drawings needed to be used in the description of the embodiments or the prior art will be introduced briefly in the following. Obviously, the drawings in the following description are only some embodiments of the disclosure, and for those of ordinary skills in the art, other drawings may be obtained according to these drawings under the premise of not paying out creative work.

FIG. 1 is a schematic top view of a counter substrate provided by an embodiment of the present disclosure;

FIG. 2 is a schematic top view of a counter substrate provided by another embodiment of the present disclosure;

FIG. 3(a) is a schematic top view of a counter substrate provided by yet another embodiment of the present disclosure;

FIG. 3(b) is an enlarged view of area A in FIG. 3(a);

FIG. 4(a) is a schematic top view of a counter substrate provided by still another embodiment of the present disclosure;

FIG. 4(b) is an enlarged view of area B in FIG. 4(a);

FIG. 5 is a schematic top view of a counter substrate provided by yet another embodiment of the present disclosure;

FIG. 6(a) is a schematic top view of a counter substrate provided by yet another embodiment of the present disclosure;

FIG. 6(b) is an enlarged view of area C in FIG. 6(a);

FIG. 7 is a schematic cross section view along DD′ direction in FIG. 6(a);

FIG. 8 is a structural schematic diagram of a liquid crystal display panel provided by an embodiment of the present disclosure; and

FIG. 9 is a flowchart of a method for eliminating bright spots in a liquid crystal display panel provided by an embodiment of the present disclosure.

### DETAILED DESCRIPTION OF THE DISCLOSURE

At present, in order to avoid the bright spots caused by foreign bodies, cleanliness requirements in the manufacturing process are very high, but this can't completely avoid the presence of foreign bodies and can lead to a substantial increase in cost.

In the following, the technical solutions in the embodiments of the disclosure will be described clearly and completely in connection with the drawings in the embodiments of the disclosure. Obviously, the described embodiments are only part of the embodiments of the disclosure, and not all of the embodiments. Based on the embodiments in the disclosure, all other embodiments obtained by those of ordinary skills in the art under the premise of not paying out creative work pertain to the protection scope of the disclosure.

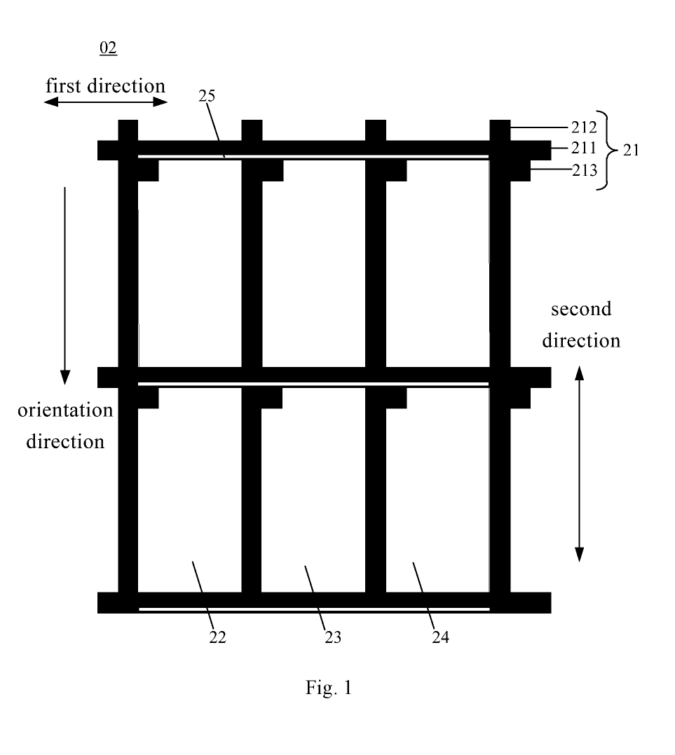

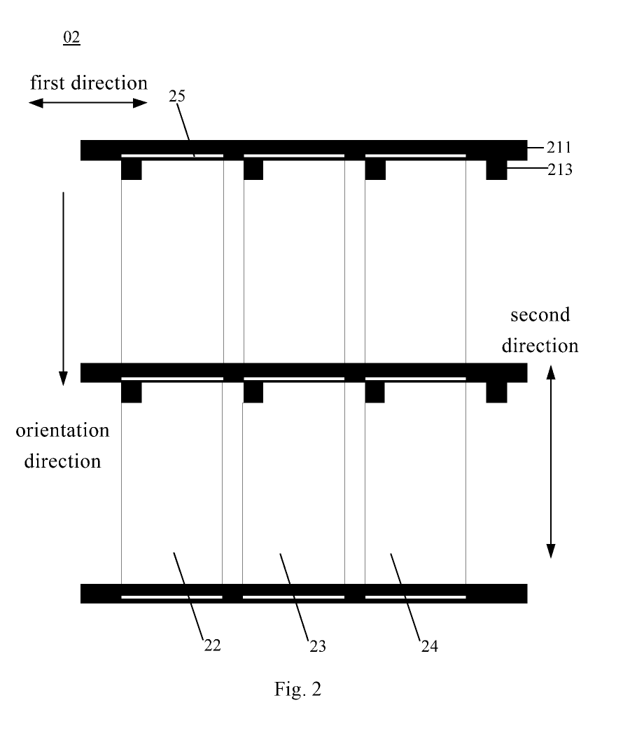

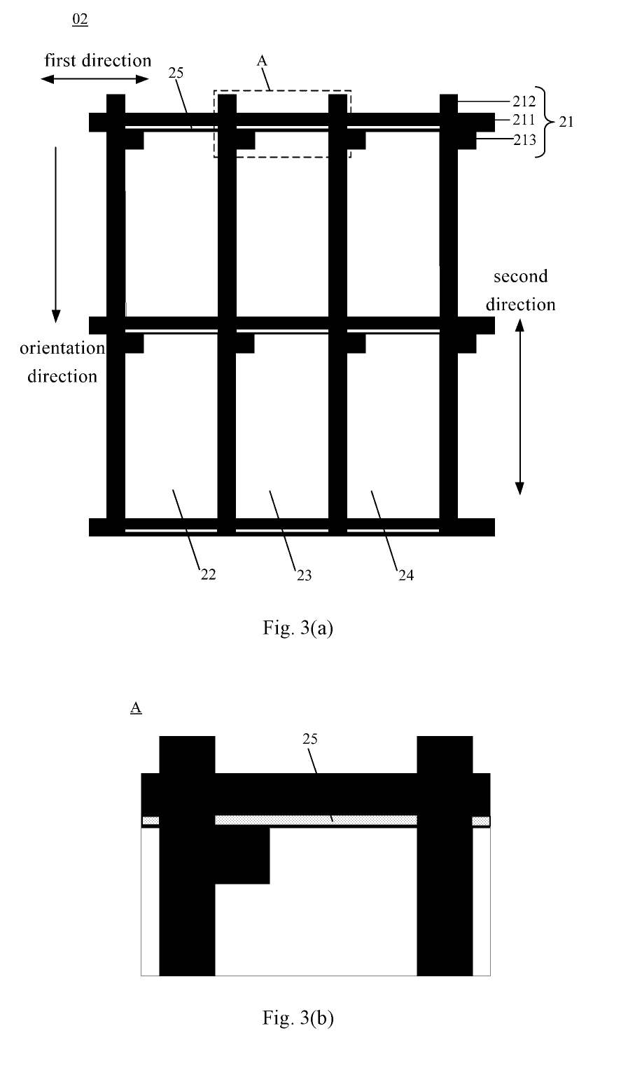

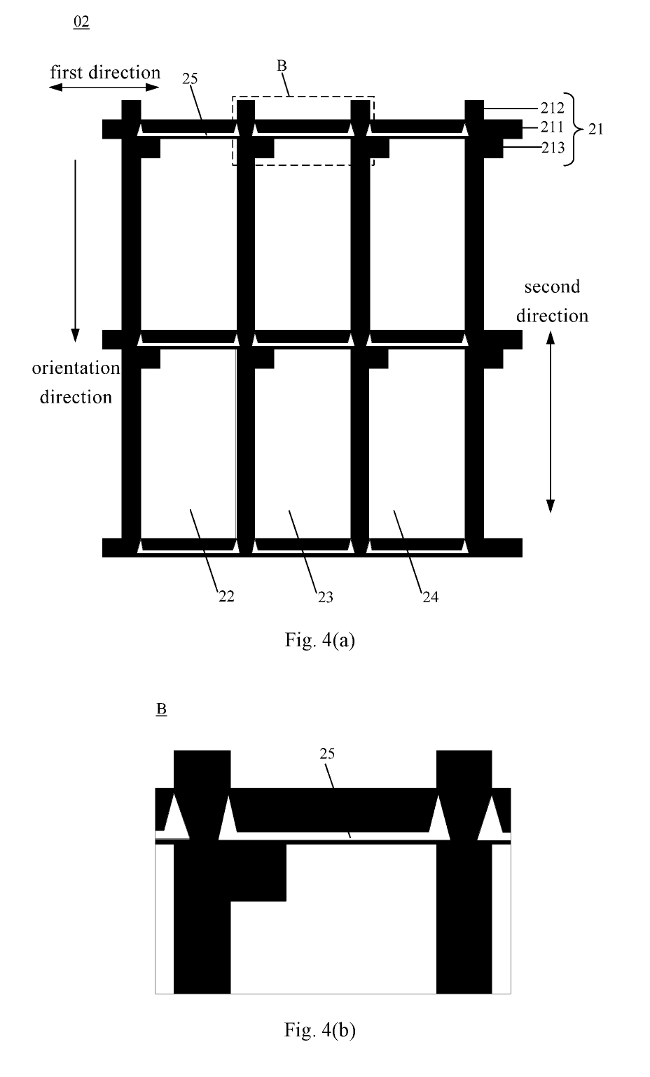

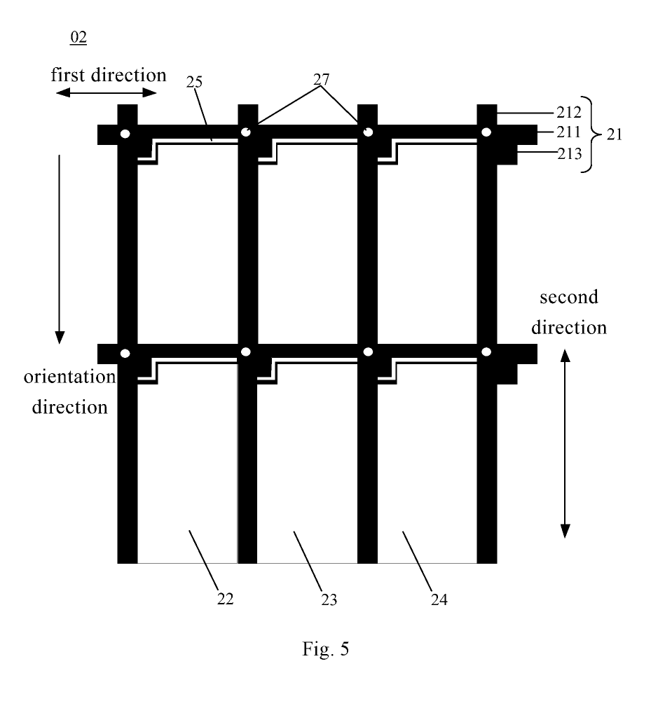

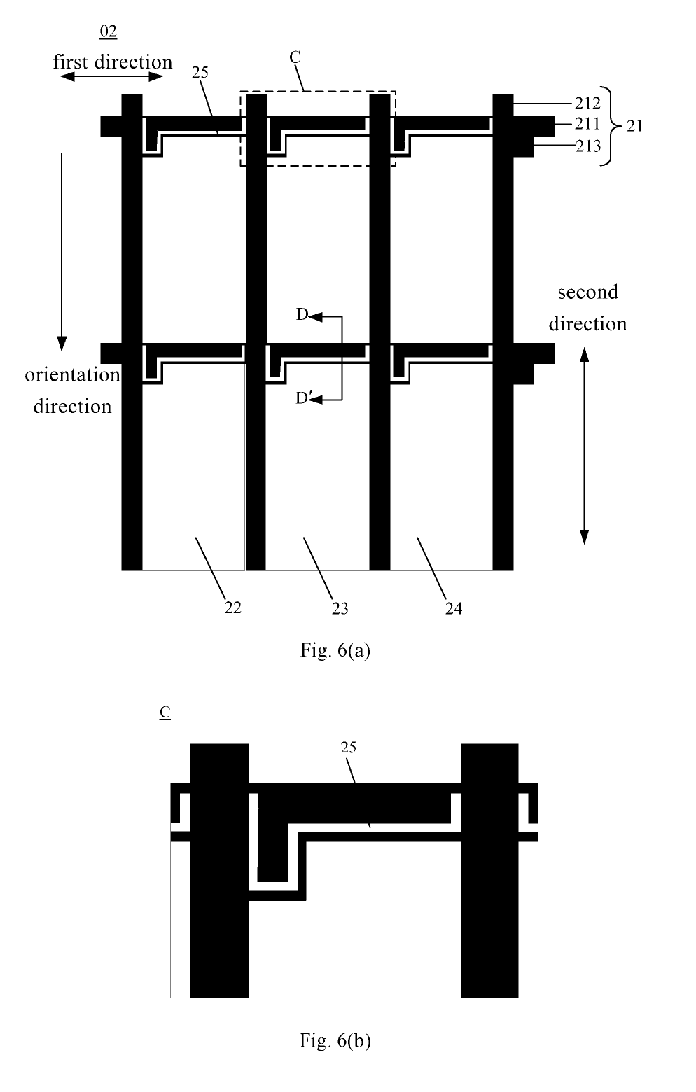

An embodiment of the present disclosure provides a counter substrate 02. As shown in FIG. 1-FIG. 7, the counter substrate 02 includes a substrate, a black matrix 21 and an orientation layer 26 disposed on the substrate, and a wall 25. The black matrix 21 at least includes a plurality of first light shielding strips 211, and an orthographic projection of the wall 25 on the substrate is covered by an orthographic projection of the plurality of first light shielding strips 211 on the substrate. The wall 25 extends along a first direction that intersects an orientation direction of the orientation layer 26, as shown in FIG. 1, FIG. 2, FIG. 3(a), FIG. 4(a), FIG. 5 and FIG. 6(a).

Of course, the counter substrate 02 can further include a color film. The color film can include a first base color filter pattern 22, a second base color filter pattern 23 and a third base color filter pattern 24. The first base color, the second base color and the third base color are three primary colors.

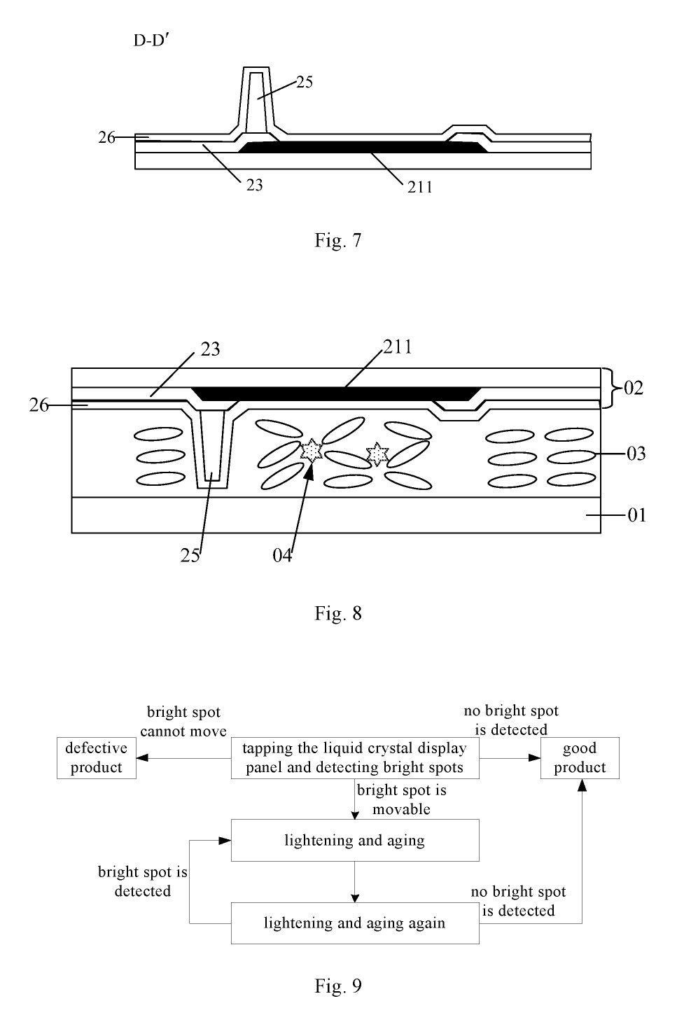

Based on this, when the counter substrate 02 includes a color film, as shown in FIG. 7, the black matrix 21 and the color film can be formed on the substrate first, then the wall 25 is formed, and finally the orientation layer 26 is formed.

It should be noted that, firstly, those skilled in the art should understand that an orientation layer 26 having an orientation direction can be prepared by a rubbing method or a photo-orientation method.

Since the orientation direction of the orientation layer 26 is unidirectional, when the counter substrate 02 is applied to a liquid crystal display panel and the liquid crystal display panel is powered, the liquid crystals therein tends to move in the orientation direction, and the liquid crystals will not move in the direction opposite to the orientation direction.

Secondly, the material of the wall 25 is not limited.

In addition, in order to prevent the foreign bodies 04 from moving across the wall 25 to the transparent area as many as possible, the height of the wall 25 should be as high as possible.

Thirdly, in order to block foreign bodies 04 as many as possible, the acute angle between the orientation direction of the orientation layer 26 and the first direction can be in the range of 60-90° (including 90°), or can be in the range of 80-90°.

The first direction is bidirectional. Exemplarily, taking the first direction perpendicular to the orientation direction of the orientation layer 26 as an example, if the orientation direction of the orientation layer 26 is the vertical direction, the first direction is the horizontal direction. Accordingly, the wall 25 extends in the horizontal direction. That is, the wall 25 can extend from left to right, extend from right to left, or extend leftward and rightward simultaneously.

Fourthly, the drawings in the embodiments of the present disclosure are only illustrated by taking the first direction perpendicular to the orientation direction of the orientation layer 26 as an example.

The embodiments of the present disclosure provide a counter substrate 02. When the counter substrate 02 is applied to the liquid crystal display panel and the liquid crystal display panel is powered, the liquid crystal molecules therein tend to move in the orientation direction of the orientation layer 26, so that the foreign bodies 04 floating in the liquid crystal layer 03 can be driven to move in the orientation direction. Based on this, in the embodiments of the present disclosure, further movement of the foreign bodies 04 can be prevented by disposing a wall. Moreover, since the wall 25 corresponds to the black matrix 21, the foreign bodies 04 blocked by the wall 25 can also be covered by the black matrix 21, so that bright spots caused by foreign bodies in the prior art can be eliminated. Therefore, the cleanliness requirements in the manufacturing process can be reduced, thereby reducing cost.

Optionally, as shown in FIG. 1-FIG. 7, the first direction is perpendicular to the orientation direction of the orientation layer 26. In this way, by properly disposing the position of the wall 25 relative to the black matrix 21, the foreign bodies 04 can be covered by the black matrix 21 as much as possible to further eliminate bright spots caused by the foreign bodies 04.

The black matrix 21 includes the first light shielding strips 211, optional second light shielding strips 212 and optional third light shielding strips 213. The purpose of providing the wall 25 is to confine the foreign bodies 04 in the area covered by the black matrix 21. The foreign bodies 04 may have different sizes. In order to confine the large-sized foreign bodies 04 at the position of the first light shielding strip 211 corresponding to the wall 25 as much as possible, as shown in FIG. 1-FIG. 7, optionally, a lateral width d of the wall 25 is smaller than a lateral width of the first light shielding strip 211. In the context of the present disclosure, “lateral” refers to the direction perpendicular to the longitudinal direction (or, extending direction) in the schematic top view.

Exemplarily, if the orientation direction is the vertical direction, the wall 25 is disposed near the lower edge of the black matrix 21, so that the foreign bodies 04 can be confined at the position of the first light shielding strip 211.

Further, the lateral width of the wall 25 is ⅕-¼ of the lateral width of the first light shielding strip 211.

Optionally, as shown in FIG. 2-FIG. 6, the number of the wall 25 is multiple. Each wall 25 corresponds to at least one sub-pixel.

Further optionally, the walls 25 correspond to the sub-pixels one-to-one.

Herein, when the counter substrate includes a color film including a first base color filter pattern 22, a second base color filter pattern 23 and a third base color filter pattern 24, each base color filter pattern is located in one sub-pixel.

In the embodiment of the present disclosure, the number of the wall 25 is multiple, so that more foreign bodies 04 can be confined in the area covered by the black matrix 21, so as to better eliminate bright spots caused by foreign bodies 04 in the prior art.

The foreign bodies may move to a gap between the adjacent walls 25 along the first direction. The gap is located between the sub-pixels and belongs to the opaque area. Therefore, the gap between the adjacent walls 25 can be made opaque through the design of the driving electric field of the liquid crystal display panel. Of course, the arrangement of the black matrix 21 can also be used to ensure that the gap between the adjacent walls 25 is opaque.

Optionally, in order to make the applicable range of the counter substrate 02 wider (i.e., applicable to any type of driving electric field), as shown in FIG. 3-FIG. 7, the black matrix 21 includes a plurality of second light shielding strips 212 extending along a second direction, the second direction is disposed to intersect with the first direction, and the walls 25 are disposed between adjacent second light shielding strips 212.

It should be noted that, firstly, both the first direction and the second direction are bidirectional.

Secondly, the end of the wall 25 may not overlap or only partially overlap with the second light shielding strips 212 extending along the second direction, which is not limited herein.

In the embodiment of the present disclosure, even if the foreign bodies 04 are located on the second light shielding strip 212 extending along the second direction, the bright spots will not occur. Based on this, material can be saved and cost can be reduced by disposing the wall 25 between the second light shielding strips 212 extending along the second direction.

Based on this, in some embodiments, the walls 25 correspond to the positions of the first light shielding strips 211. That is, as shown in FIG. 3(a) and FIG. 3(b), the walls 25 can be disposed in a “straight line” shape. The orientation direction of the actually produced orientation layer 26 can be deviated. In order to ensure that foreign bodies 04 can still be confined at the position of the black matrix 21 when there is a deviation, as shown in FIG. 4(a) and FIG. 4(b), both ends of the wall 25 along the first direction can have protrusions extending opposite to the orientation direction. Of course, the protrusions at both ends of the wall can be disposed in other shapes, which is not limited herein, as long as the foreign bodies 04 can be confined at the position of the black matrix 21 corresponding to the wall 25.

Therefore, optionally, the wall 25 has a tortuous shape.

Optionally, as shown in FIG. 6(a) and FIG. 6(b), the black matrix 21 further includes the third light shielding strips 213. The third light shielding strips 213 are disposed at the intersections of the first light shielding strips 211 and the second light shielding strips 212. The orthographic projection of the wall 25 on the substrate is covered by the orthographic projection of the first light shielding strip 211 and the third light shielding strip 213 on the substrate.

In the embodiment of the present disclosure, with a tortuous shape, no matter how the foreign bodies move in the orientation direction, they can be captured by the walls and are not apt to be released.

Of course, the walls 25 can also be disposed in the shape as shown in FIG. 5.

Based on the above, optionally, as shown in FIG. 5, the counter substrate 02 further includes spacers 27. The material of the wall 25 is the same as that of the spacers 27. The wall 25 and the spacers 27 can be formed on the same layer. With such an arrangement, the walls 25 and spacers 27 can be formed by using a one-time composition process.

In the embodiment of the present disclosure, the manufacturing process can be simplified by forming the walls 25 and the spacers 27 synchronously.

An embodiment of the present disclosure further provides a liquid crystal display panel, which includes the above-described counter substrate.

An embodiment of the present disclosure provides a liquid crystal display panel. When the liquid crystal display panel is powered, the liquid crystal molecules therein tend to move in the orientation direction of the orientation layer 26, so that foreign bodies 04 floating in the liquid crystal layer 03 can be driven to move in the orientation direction. Based on this, in the embodiments of the present disclosure, further movement of foreign bodies 04 can be prevented by disposing walls 25 on the counter substrate 02. Moreover, since the walls 25 correspond to the black matrix 21, the foreign bodies 04 blocked by the walls 25 also can be covered by the black matrix 21, so that bright spots caused by foreign bodies in the prior art can be eliminated. Therefore, the cleanliness requirements in the manufacturing process can be reduced, thereby reducing cost.

The liquid crystal display panel can include a plurality of thin film transistors. The black matrix 21 on the counter substrate 02 includes a plurality of third light shielding strips 213. An orthographic projection of each third light shielding strip 213 on the substrate of the counter substrate 02 covers the orthographic projection of each thin film transistor on the substrate.

By shielding the thin film transistors with the third light shielding strips 213, the influence of ambient light on the performance of the thin film transistors can be avoided.

Optionally, the thickness of the wall 25 is 0.1˜1 μm less than the thickness of the liquid crystal layer in the liquid crystal display panel.

In the embodiment of the present disclosure, the thickness of the wall 25 is 0.1˜1 μm less than the thickness of the liquid crystal layer in the liquid crystal display panel, so that the walls maintain the cell thickness when the liquid crystal display panel is pressed.

Exemplarily, as shown in FIG. 8, the liquid crystal display panel can include an array substrate 01, a counter substrate 02, and a liquid crystal layer 03 disposed between the array substrate 01 and the counter substrate 02.

An embodiment of the present disclosure further provides a method for eliminating bright spots in the liquid crystal display panel as described in the above embodiments. The method includes: determining whether bright spots move; and if the bright spots move, lightening and aging the liquid crystal display panel until the bright spots are blocked.

Herein, the aging time can be controlled in the range of 0.5 h to 3 h, and the aging temperature can be controlled in the range of 50° C. to 120° C. Of course, the aging time and the aging temperature can be adjusted according to the actual parameters of the liquid crystal display panel.

Specifically, as shown in FIG. 9, firstly, the surface of the liquid crystal display panel can be tapped, and it is detected whether there are bright spots and whether the bright spots move. If no bright spot is detected, the liquid crystal display panel is a good product. If bright spots are detected and the bright spots cannot move, the liquid crystal display panel is a defective product. If bright spots are detected and the bright spots are movable, the liquid crystal display panel is lightened and aged until the bright spots are blocked.

It should be noted that the step “lightening and aging the liquid crystal display panel until the bright spots are blocked” means that if bright spots can be detected even after an aging process is completed, a next round of aging is performed until the bright spots are blocked and cannot be seen.

In the embodiments of the present disclosure, when the liquid crystal display panel is powered, the liquid crystal molecules therein tend to move in the orientation direction of the orientation layer, so that the foreign bodies floating in the liquid crystal layer can be driven to move in the orientation direction. Based on this, in the embodiments of the present disclosure, further movement of the foreign bodies can be prevented by disposing walls. Moreover, since the walls correspond to the black matrix, the foreign bodies blocked by the walls also can be covered by the black matrix, so that bright spots caused by foreign bodies in the prior art can be eliminated. Therefore, the cleanliness requirements in the manufacturing process can be reduced, thereby reducing cost.

The above embodiments are only used for explanations rather than limitations to the present disclosure, the ordinary skilled person in the related technical field, in the case of not departing from the spirit and scope of the present disclosure, may also make various modifications and variations, therefore, all the equivalent solutions also belong to the scope of the present disclosure, the patent protection scope of the present disclosure should be defined by the claims.

1. A counter substrate, comprising a substrate, a black matrix and an orientation layer disposed on the substrate, and a wall;
wherein the black matrix at least comprises a plurality of first light shielding strips, and an orthographic projection of the wall on the substrate is covered by an orthographic projection of the plurality of first light shielding strips on the substrate;
wherein the wall extends along a first direction and the first direction intersects an orientation direction of the orientation layer.

2. The counter substrate according to claim 1, wherein the first direction is perpendicular to the orientation direction of the orientation layer.

3. The counter substrate according to claim 1, wherein a lateral width of the wall is smaller than a lateral width of the first light shielding strip.

4. The counter substrate according to claim 1, wherein the black matrix comprises a plurality of second light shielding strips extending along a second direction, the second direction is disposed to intersect with the first direction, and the wall is disposed between adjacent second light shielding strips.

5. The counter substrate according to claim 4, wherein the wall has a tortuous shape.

6. The counter substrate according to claim 4, wherein the black matrix further comprises a plurality of third light shielding strips and the third light shielding strips are disposed at the intersections of the first light shielding strips and the second light shielding strips;
wherein the orthographic projection of the wall on the substrate is covered by an orthographic projection of the first light shielding strips and the third light shielding strips on the substrate.

7. The counter substrate according to claim 4, wherein both ends of the wall along the first direction have protrusions extending opposite to the orientation direction.

8. The counter substrate according to claim 1, wherein the number of the wall is multiple, and each wall corresponds to at least one sub-pixel.

9. The counter substrate according to claim 1, wherein the counter substrate further comprises spacers;
wherein the material of the wall is the same as that of the spacers; the wall and the spacers are formed on the same layer.

10. A liquid crystal display panel, comprising the counter substrate according to claim 1.

11. The liquid crystal display panel according to claim 10, wherein the liquid crystal display panel comprises thin film transistors;
wherein the black matrix on the counter substrate comprises a plurality of third light shielding strips, and an orthographic projection of the third light shielding strips on the substrate of the counter substrate covers an orthographic projection of the thin film transistors on the substrate.

12. The liquid crystal display panel according to claim 10, wherein a height of the walls is 0.1˜1 μm less than a thickness of a liquid crystal layer in the liquid crystal display panel.

13. A method for eliminating bright spots in the liquid crystal display panel according to claim 10, comprising:
determining whether bright spots move;
if bright spots move, lightening and aging the liquid crystal display panel until bright spots are blocked.

14. The method according to claim 13, wherein an aging time is in a range of 0.5-3 h, and an aging temperature is in a range of 50-120° C.

15. The liquid crystal display panel according to claim 10, wherein the first direction is perpendicular to the orientation direction of the orientation layer.

16. The liquid crystal display panel according to claim 10, wherein a lateral width of the wall is smaller than a lateral width of the first light shielding strip.

17. The liquid crystal display panel according to claim 10, wherein the black matrix comprises a plurality of second light shielding strips extending along a second direction, the second direction is disposed to intersect with the first direction, and the wall is disposed between adjacent second light shielding strips.

18. The liquid crystal display panel according to claim 17, wherein the wall has a tortuous shape.

19. The liquid crystal display panel according to claim 17, wherein both ends of the wall along the first direction have protrusions extending opposite to the orientation direction.

20. The liquid crystal display panel according to claim 10, wherein the number of the wall is multiple, and each wall corresponds to at least one sub-pixel.
